(19) United States
(12) Patent Application Publication
(10) Pub. No.: US 2006/0098818 A1
(43) Pub. Date: May 11, 2006

(54) Encryption technique for asynchronous control commands and data

(75) Inventors: Nicholas D. Fifer, Tucson, AZ (US); Robert F. Bartfai, Tucson, AZ (US); William F. Micka, Tucson, AZ (US); Warren K. Stanley, Loveland, CO (US); Kenneth F. Day III, Tucson, AZ (US); Kenneth W. Boyd, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines (IBM) Corporation, Armonk, NY (US)

(21) Appl. No.: 10/986,477

(22) Filed: Nov. 10, 2004

(51) Int. Cl. H04K 1/06

(52) U.S. Cl. 380/37

(57) ABSTRACT

A method of transmitting information from a primary storage control unit to a secondary storage control unit in an asynchronous data copying system. The method includes building multiple descriptor blocks for transmission from the primary storage control unit, and encrypting multiple payloads according to one of n encryption methods. In addition, the n encryption methods are associated with the primary storage control unit and n decryption keys relating to the n encryption methods are associated with the secondary storage control unit. An index to the n encryption keys is associated with the multiple descriptor blocks. The method further includes encrypting each of the payloads according to one of the n encryption methods and indicating, in the index associated with a selected descriptor block, which decryption key relates to the encryption method used for any payload associated with a select descriptor block. Upon transmission of a descriptor block from the primary storage control unit to the secondary storage control unit, the index is read and an appropriate decryption key is applied according to a decryption method to decrypt any payload associated with the descriptor block.

### TECHNICAL FIELD

The present invention relates to a method, system and article of manufacture for the transmission of encrypted digital information associated with data copying from a master storage controller to a subordinate storage controller in an asynchronous data copying environment.

### BACKGROUND ART

Information technology systems, including storage systems, may need protection from site disasters or outages, where outages may be planned or unplanned. Furthermore, information technology systems may require features for data migration, data backup, or data duplication. Implementations for disaster or outage recovery, data migration, data backup, and data duplication may include mirroring or copying of data between storage control units. Such mirroring or copying of data may involve interactions among hosts and storage servers across the connecting networking components of an information technology system.

A storage server, such as the IBM® TotalStorage® Enterprise Storage Server® (“ESS”), may be a disk storage server that includes one or more processors coupled to storage devices, including high capacity scalable storage devices, Redundant Array of Inexpensive (or Independent) Disks (“RAID”) or other typically disk-based storage systems.

Peer-to-Peer Remote Copy (“PPRC”) is an ESS function that allows the shadowing of application system data from a first site to a second site. The first site may be referred to as an application site, a local site, or a primary site. The second site may be referred to as a recovery site, a remote site or a secondary site. The logical volumes that hold the data in the ESS at the primary site are called primary volumes, and the corresponding volumes that hold the mirrored data at the secondary site are called secondary volumes. High speed data links may connect the primary and secondary ESS systems.

In Extended Distance PPRC implementations, PPRC mirrors the updates of the primary volumes onto the secondary volumes in an asynchronous manner, while the host application is running. In asynchronous PPRC, the host application receives a write complete response before the update is copied from the primary volumes to the secondary volumes and a host application's write operations are free of the typical synchronous overheads. Therefore, asynchronous PPRC is suitable for secondary copy solutions at very long distances with minimal impact on host applications.

In a typical asynchronous PPRC system, the primary and secondary storage systems will communicate with each other over lines, connections or links which also are accessible to other switches or equipment connected in the path between the controllers. Typically, the PPRC control commands transmitted from the primary server to the secondary server are not encrypted in any fashion. Similarly, the data packet to be copied from the primary to the secondary, which is transmitted in association with the PPRC control commands, has not been encrypted. Thus, both the PPRC control commands and the mirrored data are accessible to other servers or switches which may interface with the connection between a primary and secondary PPRC controller.

Since no encryption or other security measures exist to preserve the integrity of control commands or data transmitted from a primary to a secondary storage controller in an asynchronous PPRC relationship, a malicious intruder could compromise the mirroring of data by issuing corrupted control commands or by directly corrupting the mirrored data.

The present invention is directed to overcoming one or more of the problems discussed above.

### SUMMARY OF THE INVENTION

A first embodiment of the present invention is a method of transmitting information from a primary storage control unit to a secondary storage control unit in an asynchronous data copying system. The method includes building a descriptor block for transmission from the primary storage control unit, encrypting a command or data payload according to an encryption method, and associating the payload with the descriptor block. In addition, the method includes transmitting the descriptor block and payload from the primary storage control unit to the secondary storage control unit, and decrypting the payload.

In an alternative embodiment, multiple descriptor blocks are built for transmission from the primary storage control unit, and multiple payloads are encrypted according to one of n encryption methods. In addition, n encryption methods are associated with the primary storage control unit and n decryption keys relating to the n encryption methods are associated with the secondary control unit, with n being defined as a select number greater than 1. Also, an index to the n decryption keys is associated with the multiple descriptor blocks. This method further includes encrypting each of the payloads according to one of the n encryption methods, and indicating in the index associated with a select descriptor block which decryption key relates to the encryption method used for any payload associated with the select descriptor block.

More than n descriptor blocks may be built for transmission from the primary storage control unit, and more than n payloads may be encrypted. In such an implementation, a cycle may be applied to select one of the n encryption methods to encrypt each of the more than n payloads.

Alternatively, an election may be made not to encrypt a select unencrypted payload. In this case, an indication will be made in the index that no encryption method was used on the unencrypted payload.

In any embodiment, a payload may be digital information including one or more asynchronous copy commands or data to be copied from the primary storage control unit to the secondary storage control unit in an asynchronous PPRC relationship.

### BRIEF DESCRIPTION OF THE DRAWINGS

FIG. 1 is a block diagram of a computing environment in which aspects of the invention may be implemented;

FIG. 2 is a block diagram representation of information transmitted between storage servers in an asynchronous PPRC relationship; and

FIG. 3 is a flowchart illustrating logic in accordance with certain described implementations of the invention.

### DETAILED DESCRIPTION OF THE PREFERRED EMBODIMENT

In the following description, reference is made to the accompanying drawings which form a part hereof and which illustrate several implementations. It is understood that other implementations may be utilized and structural and operational changes may be made without departing from the scope of the present limitations.

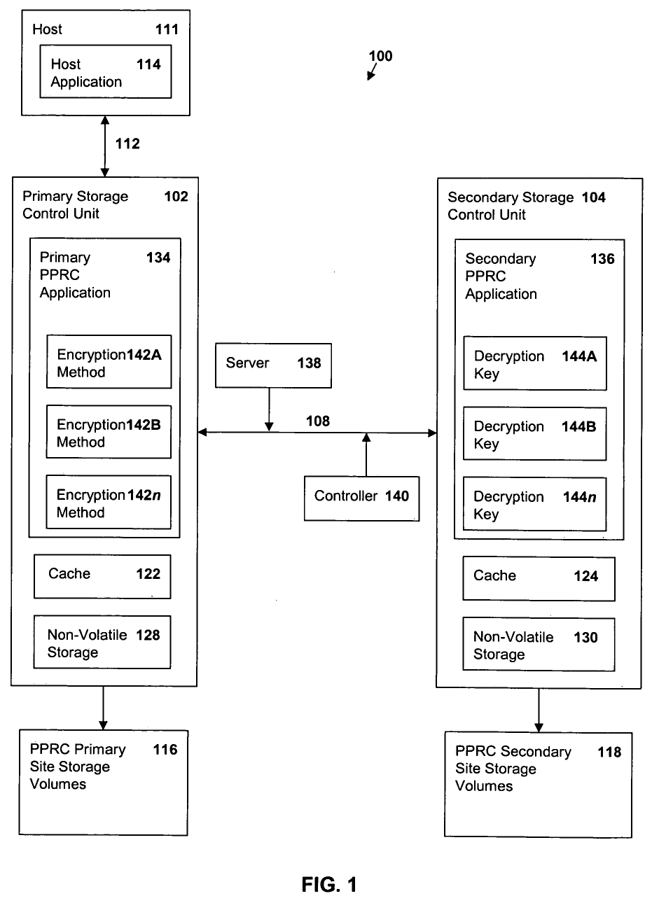

FIG. 1 illustrates a computing environment 100 utilizing two storage control units, such as a primary storage control unit 102 and a secondary storage control unit 104 connected by a data interface channel 108, such as a high speed fiber optic channel or any other data interface mechanism known in the art (e.g., fibre channel, Storage Area Network (SAN), Wide Area Network (WAN), etc.). The two storage control units 102 and 104 may be at two different sites and asynchronously interconnected. Additionally, the secondary storage control unit 104 may be in a secure environment separated from the primary storage control unit 102 and with separate power to reduce the possibility of an outage affecting both the primary storage control unit 102 and the secondary storage control unit 104.

The primary storage control unit 102, along with the primary storage volumes 116, may be among several (or many) storage controllers and storage volumes at a local site or sites. Similarly, the secondary storage control unit 104, along with the secondary storage volumes 118, may be among several (or many) storage controllers and storage volumes at a remote site or sites.

The primary storage control unit 102 is typically coupled to a host 111 via data interface channel 112. While only a single host 111 is shown coupled to the primary storage control unit 102, a plurality of hosts may be coupled to the primary storage control unit 102. The host 111 may be any computational device known in the art, such as a personal computer, a workstation, a server, a mainframe, a hand held computer, a telephony device, a network appliance, etc. The host 111 may include any operating system (not shown) known in the art, such as the IBM OS/390® operating system. The host 111 may include at least one host application 114 that sends Input/Output (I/O) requests (including write requests) to the primary storage control unit 102.

The storage control units 102 and 104 are coupled to storage volumes such as primary site storage volumes 116 and secondary site storage volumes 118, respectively. The storage volumes 116 and 118 may be configured as a Direct Access Storage Device (DASD), one or more RAID ranks, just a bunch of disks (JBOD), or any other data repository system known in the art. The storage control units 102 and 104 may each include a cache, such as caches 122 and 124 respectively. The caches 122 and 124 comprise volatile memory to store data blocks (for example, formatted as tracks). The storage control units 102 and 104 may each include a non-volatile storage (NVS), such as non-volatile storage 128 and 130 respectively. The non-volatile storage 128 and 130 elements may buffer certain modified data blocks in the caches 122 and 124 respectively.

The primary storage control unit 102 additionally includes an application, such as a primary PPRC application 134, for asynchronous copying of data stored in the cache 122, non-volatile storage 128 and primary site storage volumes 116 to another storage control unit, such as the secondary storage control unit 104. The primary PPRC application 134 includes functions which execute in the primary storage control unit 102.

The secondary storage control unit 104 additionally includes an application such as a secondary PPRC application 136. The secondary PPRC application 136 includes functions that execute in the secondary storage control unit 104. The secondary PPRC application 136 can interact with the primary storage control unit 102 to receive data asynchronously over the data interface channel 108.

Therefore, FIG. 1 illustrates a computing environment in which a host application 114 sends I/O requests to a primary storage control unit 102. The primary storage control unit 102 asynchronously copies data to the secondary storage control unit 104. As a result of efficiencies inherent in the asynchronous copying process, the effect of long distance on the host response time is eliminated.

Accordingly, the data interface channels 108 may extend over virtually any distance up to transcontinental distances. It is not unusual for many other devices other than the primary storage control unit 102 and the secondary storage control unit 104 to have access to the data interface channel 108 at various points across this distance. For example, as shown on FIG. 1, a server 138 or a controller 140 may interface with the data interface channel 108. The server 138 and the controller 140 are merely representative examples of other devices which may connect to or have network access to the data interface channel 108 over its length. Other types of devices of any number may also connect to or have network access to the data interface channel 108. Each of these devices which is not engaged in the PPRC relationship between the primary storage control unit 102 and the secondary storage control unit 104 will nonetheless have the potential to access both the PPRC control commands and the data transmitted between the storage control units 102, 104. If an unauthorized device does access the date interface channel 108, it is possible that the device could be used to initiate maliciously structured PPRC control commands, ultimately causing a failure of the data copying process.

The logic for processing a write request will be described briefly. Control begins when the primary PPRC application 134 receives a write request from the host application 114. The primary PPRC application 134 writes data corresponding to the write request in the cache 122 and the non-volatile storage 128 on the primary storage control unit 102. Once the data is stored in the cache 122 and NVS 128, the primary PPRC application 134 signals to the host application 114 that the write request from the host application 114 has been completed at the primary storage control unit 102. The primary PPRC application 134 may then receive one or more subsequent write requests from the host application 114. Additional applications (not shown), such as caching applications and non-volatile storage applications, in the primary storage control unit 102 may manage the data in the cache 122 and the data in the non-volatile storage 128 and keep the data in the cache 122 and the non-volatile storage 128 consistent with the data in the primary site storage volumes 116.

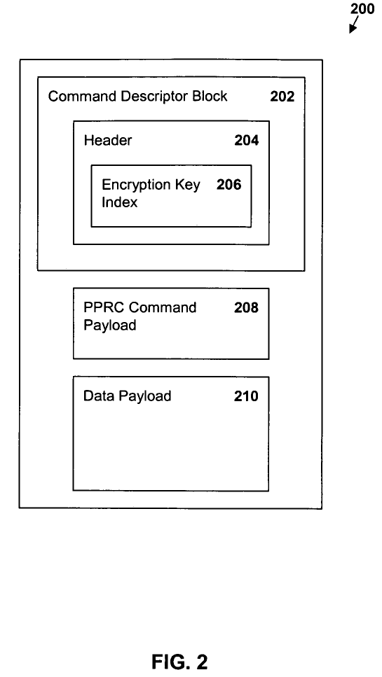

Periodically, and asynchronously, the primary storage control unit 102 through the primary PPRC application 134 will transmit information for copying to the secondary storage control unit 104. The information may include both data and control commands. As used herein, “information” as defined above is synonymous with a transmission sent or to be sent from the primary storage control unit 102 to the secondary storage control unit 104. As shown in FIG. 2, a transmission 200 to be sent from the primary storage control unit 102 to the secondary storage control unit 104 may include three distinct components. The first component of the transmission 200 is a descriptor block which can be a command descriptor block (CDB) 202. The CDB 202 may include a header 204 and an index 206 as described herein. Additionally, the transmission 200 may include a PPRC command payload 208 which includes typical PPRC control commands sent from the primary storage control unit 102 to the secondary storage control unit 104. PPRC control commands typically are used to create and process proper data consistency groups. The transmission 200 may also include a data payload 210 which is transmitted for mirrored copying from the primary storage control unit 102 to the secondary storage control unit 104.

In prior art extended distance PPRC implementations, the information transmitted from the primary storage control unit 102 to the secondary storage control unit 104 was transmitted without any encryption or other security measures. Thus, unrelated devices with access to the data interface channel 108 could access the transmission 200 and potentially cause two distinct and separate types of problems. In the first instance, a malicious intruder could potentially access the PPRC command payload 208. The intentional or unintentional corruption of the PPRC command payload 208 could cause a failure in the data mirroring operations. For example, commands could be maliciously issued in the wrong order, resulting in a failure to maintain proper asynchronous data consistency groups. In the second instance, a malicious intruder could directly corrupt the data payload 210 transmitted from the first storage control unit 102 to the secondary storage control unit 104.

By encrypting the payloads 208, 210 transmitted between the primary storage control unit 102 and the secondary storage control unit 104, a measure of security is introduced which will help ensure data integrity and consistency.

Various types of encryption methods are known in the computing arts. In one encryption method, decryption keys are exchanged along with each command between the storage control units 120, 104. Alternatively, decryption keys could be exchanged between the storage control units 102, 104 at the initial connection between the storage control units 102, 104. A shortcoming with these encryption/decryption methods is that the decryption keys could be intercepted en route between the storage control units 102, 104.

The shortcomings inherent in the transmission of decryption keys along with a transmission 200 sent between the storage control units 102, 104 can be avoided in an exemplary embodiment where decryption keys are incorporated into the software associated with each storage control unit 102, 104. For example, a set of encryption method algorithms 142A, 142B . . . 142n can be included in the primary PPRC application 134 and a corresponding set of decryption keys 144A, 144B . . . 144n can be included in the secondary PPRC application 136. Thus, the risk of interception of the decryption keys by a malicious intruder is minimized. In addition, the decryption keys can be changed periodically between code loads on the storage control units to add an additional level of security.

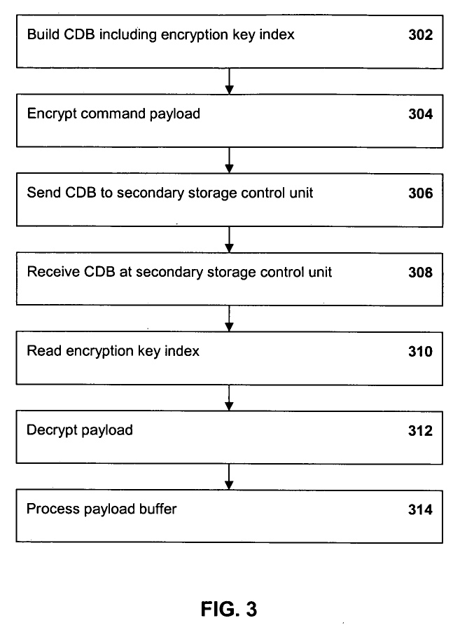

FIG. 3 illustrates the logic used in an exemplary method of encryption which utilizes the command descriptor block 202 transmitted between the storage control units 102, 104. The encryption method commences when data stored to the primary storage control unit 102 is prepared for transmission to the secondary storage control unit 104. As discussed above, the preparation of a transmission 200 in the asynchronous PPRC relationship is a function of the primary PPRC application 134.

Prior to transmission of the data, a command descriptor block (CDB) 202 is built by the primary PPRC application 134. The command descriptor block 202 includes an encryption key index 206 (step 302). The encryption key index 206 can be associated with the CDB header 204, and indicates which of the decryption keys 144A, 144B . . . 144n will be used at the secondary storage control unit 104 to decrypt any payload 208, 210 which has been encrypted according to an encryption method 142A, 142B . . . 142n at the primary PPRC application 134. Either the PPRC command payload 208 or the data payload 210 may be encrypted, or alternatively both of these portions of the transmission 200 may be encrypted.

After the CDB 202 has been built, the PPRC command payload 208 may be encrypted according to one of the encryption methods 142A, 142B . . . 142n (step 304). Alternatively, the data payload 210 may similarly be encrypted according to one of the encryption methods 142A, 142B . . . 142n. Subsequent to encryption, the CDB 202 and associated payloads 208, 210 may be transmitted from the primary storage control unit 102 (step 306), and received at the secondary storage control unit 104 (step 308).

Upon receipt of the CDB 202, the encryption key index 206 associated with the CDB 202 is read to determine which decryption key 144A, 144B . . . 144n can be used to decrypt the PPRC command payload 208, or the data payload 210, or both (step 310). Decryption may then take place at the secondary PPRC application 136 (step 312). Upon decryption, the commands in the PPRC command payload 208 may be processed and/or the data in the data payload 210 may be stored as is typical in an asynchronous PPRC relationship (step 314).

An initial level of security may be obtained by employing a single encryption method. In such an embodiment, it would be unnecessary to associate an encryption key index 206 with the CDB 202. However, an additional level of security is obtained by employing n multiple encryption methods 142A, 142B . . . 142n at the primary PPRC application 134, thus necessitating the use of an encryption key index 206. Preferably, the encryption methods 142A, 142B . . . 142n will be cycled in a select fashion to reduce the risk of intruder access to the system. The use of an encryption key index 206 will also allow some commands or data to selectively not be encrypted. In such an implementation, a “do not encrypt” element may be included in the encryption key index 206. Thus, a user will be able to avoid the encryption of commands that either require no extra security measures or commands that must communicate to a code level prior to the code level containing the encryption control commands.

Although described above with respect to a two controller system, those skilled in the art will recognize that an actual implementation of an asynchronous PPRC data mirroring system may contain multiple controllers which act at various times as primary and secondary storage control units 102, 104. It is possible under the above described implementation to have somewhat differing levels of encryption methods or code levels on each of the storage control units 102, 104 involved, so long as the primary storage control unit 102 has the ability to discover the level of decryption keys stored on each secondary storage control unit 104. In such an embodiment, the primary storage control unit 102 can select suitable encryption methods and attach a suitable encryption key index 206 to any CDB 202 transmitted to a given secondary storage control unit 104. Even though each secondary storage control unit 104 may have different decryption keys 144A, 144B . . . 144n, the same encryption key indexes 206 may be rotated through, however, the key indexes will index into different key arrays for each secondary storage control unit 104.

The described techniques for encrypting asynchronous control commands and data may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., magnetic storage medium such as hard disk drives, floppy disks, tape), optical storage (e.g., CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which implementations are made may further be accessible through a transmission media or from a file server over a network. In such cases, the article of manufacture in which the code is implemented may comprise a transmission media such as network transmission line, wireless transmission media, signals propagating through space, radio waves, infrared signals, etc. Of course, those skilled in the art will recognize that many modifications may be made to this configuration without departing from the scope of the implementations and that the article of manufacture may comprise any information bearing medium known in the art.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims. Moreover, although described above with respect to an apparatus, the need in the art may also be met by a method of an encryption technique for asynchronous control commands and data, a computer program product containing instructions for an encryption technique for asynchronous control commands and data, or a method for deploying computing infrastructure comprising integrating computer readable code into a computing system for an encryption technique for asynchronous control commands and data.

1. A method of transmitting information from a primary storage control unit to a secondary storage control unit in an asynchronous data copying system, the method comprising:
building a descriptor block for transmission from the primary storage control unit;
encrypting a payload according to an encryption method;
associating the payload with the descriptor block;
transmitting the descriptor block and associated payload from the primary storage control unit to the secondary storage control unit; and
decrypting the payload according to a decryption method.

2. The method of claim 1 further comprising:
encrypting multiple payloads, with each payload encrypted according to one of n encryption methods with n being defined as a select number greater than one; and
associating each of the multiple payloads with one of multiple descriptor blocks.

3. The method of claim 2 further comprising:
associating the n encryption methods with the primary storage control unit;
associating n decryption keys relating to the n encryption methods with the secondary storage control unit; and
associating an index to the n decryption keys with the multiple descriptor blocks.

4. The method of claim 3 further comprising indicating in the index associated with a select descriptor block which decryption key relates to the encryption method used for any payload associated with the select descriptor block.

5. The method of claim 4 further comprising:
encrypting more than n payloads; and
applying a cycle to select one of the n encryption methods to encrypt each of the more than n payloads.

6. The method of claim 4 further comprising:
electing not to encrypt a select unencrypted payload; and
indicating in the index that no encryption method was used on the unencrypted payload.

7. The method of claim 1 wherein the payload is digital information selected from a group consisting of:
a control command; and
data to be copied from the primary storage control unit to the secondary storage control unit.

8. The method of claim 1 wherein the descriptor block is a command descriptor block.

9. The method of claim 3 wherein the index is included in an initial header associated with the descriptor block.

10. An asynchronous data copying system comprising:
a primary storage control unit comprising means for building a descriptor block for transmission from the primary storage control unit, encrypting a payload according to an encryption method and associating the payload with the descriptor block;
a secondary storage control unit having means for decrypting the payload according to a decryption method; and
a digital communication line connecting the primary storage unit to the secondary storage unit.

11. The asynchronous data copying system of claim 10 wherein the primary storage control unit further comprises means for:
encrypting multiple payloads, with each payload encrypted according to one of n encryption methods with n being defined as a select number greater than one; and
associating each of the multiple payloads with one of multiple descriptor blocks.

12. The asynchronous data copying system of claim 11 wherein the primary storage control unit further comprises means for:
associating the n encryption methods with the primary storage control unit;
associating n decryption keys relating to the n encryption methods with the secondary storage control unit; and
associating an index to the n decryption keys with the multiple descriptor blocks.

13. The asynchronous data copying system of claim 12 wherein the primary storage control unit further comprises means for indicating in the index associated with a select descriptor block which decryption key relates to the encryption method used for any payload associated with the select descriptor block.

14. The asynchronous data copying system of claim 13 wherein the primary storage control unit further comprises means for:
encrypting more than n payloads; and
applying a cycle to select one of the n encryption methods to encrypt each of the more than n payloads.

15. The asynchronous data copying system of claim 13 wherein the primary storage control unit further comprises means for:
electing not to encrypt a select unencrypted payload; and
indicating in the index that no encryption method was used on the unencrypted payload.

16. The asynchronous data copying system of claim 10 wherein the payload is digital information selected from a group consisting of:
a control command; and
data to be copied from the primary storage control unit to the secondary storage control unit.

17. The asynchronous data copying system of claim 10 wherein the descriptor block is a command descriptor block.

18. The asynchronous data copying system of claim 12 wherein the index is included in an initial header associated with the descriptor block.

19. An article of manufacture for use in programming a storage system to transmit information from a primary storage control unit to a secondary storage control unit in an asynchronous data copying system, the article of manufacture comprising instructions for:
building a descriptor block for transmission from the primary storage control unit;
encrypting a payload according to an encryption method;
associating the payload with the descriptor block;
transmitting the descriptor block and associated payload from the primary storage control unit to the secondary storage control unit; and
decrypting the payload according to a decryption method.

20. The article of manufacture of claim 19 further comprising instructions for:
encrypting multiple payloads, with each payload encrypted according to one of n encryption methods with n being defined as a select number greater than one; and
associating each of the multiple payloads with one of multiple descriptor blocks.

21. The article of manufacture of claim 20 further comprising instructions for:
associating the n encryption methods with the primary storage control unit;
associating n decryption keys relating to the n encryption methods with the secondary storage control unit; and
associating an index to the n decryption keys with the multiple descriptor blocks.

22. The article of manufacture of claim 21 further comprising instructions for indicating in the index associated with a select descriptor block which decryption key relates to the encryption method used for any payload associated with the select descriptor block.

23. The article of manufacture of claim 22 further comprising instructions for:
encrypting more than n payloads; and
applying a cycle to select one of the n encryption methods to encrypt each of the more than n payloads.

24. The article of manufacture of claim 22 further comprising instructions for:
electing not to encrypt a select unencrypted payload; and
indicating in the index that no encryption method was used on the unencrypted payload.

25. The article of manufacture of claim 19 wherein the payload comprises digital information selected from a group consisting of:
a control command; and
data to be copied from the primary storage control unit to the secondary storage control unit.

26. The article of manufacture of claim 19 wherein the descriptor block is a command descriptor block.

27. The article of manufacture of claim 21 wherein the index is included in an initial header associated with the descriptor block.

28. A method for deploying computing infrastructure, comprising integrating computer readable code into a computing system, wherein the code in combination with the computing systems is capable of performing the following:
building a descriptor block for transmission from the primary storage control unit;
encrypting a payload according to an encryption method;
associating the payload with the descriptor block;
transmitting the descriptor block and associated payload from the primary storage control unit to the secondary storage control unit; and
decrypting the payload according to a decryption method.

29. The method of deploying computing infrastructure of claim 28, wherein the code in combination with the computing system is further capable of performing the following:
encrypting multiple payloads, with each payload encrypted according to one of n encryption methods with n being defined as a select number greater than one; and
associating each of the multiple payloads with one of multiple descriptor blocks.

30. The method of deploying computing infrastructure of claim 29, wherein the code in combination with the computing system is further capable of performing the following:
associating the n encryption methods with the primary storage control unit;
associating n decryption keys relating to the n encryption methods with the secondary storage control unit; and
associating an index to the n decryption keys with the multiple descriptor blocks.

31. The method of deploying computing infrastructure of claim 30, wherein the code in combination with the computing system is further capable of indicating in the index associated with a select descriptor block which decryption key relates to the encryption method used for any payload associated with the select descriptor block.

32. The method of deploying computing infrastructure of claim 31, wherein the code in combination with the computing system is further capable of performing the following:
encrypting more than n payloads; and
applying a cycle to select one of the n encryption methods to encrypt each of the more than n payloads.

33. The method of deploying computing infrastructure of claim 31, wherein the code in combination with the computing system is further capable of performing the following:
electing not to encrypt a select unencrypted payload; and
indicating in the index that no encryption method was used on the unencrypted payload.

34. The method of deploying computing infrastructure of claim 28 wherein the code in combination with the computer system is further capable of selecting the payload from a group consisting of:
a control command; and
data to be copied from the primary storage control unit to the secondary storage control unit.

35. The method of deploying computing infrastructure of claim 28 wherein the descriptor block is a command descriptor block.

36. The method of deploying computing infrastructure of claim 28 wherein the index is included in an initial header associated with the descriptor block.
